(19) United States
(12) Patent Application Publication
(10) Pub. No.: US 2013/0272742 A1
(43) Pub. Date: Oct. 17, 2013

(54) DC/DC CONVERTER AND IMAGE FORMING APPARATUS INCLUDING THE SAME

(71) Applicant: CANON KABUSHIKI KAISHA, Tokyo (JP)

(72) Inventors: Shinichiro Matsumoto, Yokohama-shi (JP); Masahiro Hayakawa, Odawara-shi (JP); Kenji Nemoto, Kawasaki-shi (JP); Toshiki Takajo, Tokyo (JP)

(73) Assignee: CANON KABUSHIKI KAISHA, Tokyo (JP)

(21) Appl. No.: 13/842,033

(22) Filed: Mar. 15, 2013

(30) Foreign Application Priority Data
Apr. 11, 2012 (JP) 2012-090443

(51) Int. Cl. H02M 3/156; G03G 15/00

(52) U.S. Cl. CPC H02M 3/156
USPC 399/88; 323/290; 323/284

(57) ABSTRACT

A converter includes a switching unit configured to switch a voltage to be input, an inductor connected to the switching unit, a conversion unit configured to convert the voltage switched by the switching unit to be supplied to the inductor into a direct current voltage, a detection unit configured to detect the direct current voltage converted by the conversion unit, and a correction unit configured to correct the detected voltage detected by the detection unit, wherein an operation of the switching unit is controlled based on the voltage corrected by the correction unit.

### BACKGROUND OF THE INVENTION

1. Field of the Invention

The present invention relates to a direct current (DC)/DC converter.

2. Description of the Related Art

FIG. 13 illustrates a conventional DC/DC converter. An input voltage Vin is supplied to a field-effect transistor (FET) FET1 that is a switching element. The FET FET1 is driven (or switched on) to supply a pulse voltage to an inductor Ls. This pulse voltage is converted into a DC voltage via the inductor Ls, a diode Ds, and a capacitor Cs to be an output voltage Vout. The output voltage Vout is supplied to a V+ terminal of a comparator Cmp1. On the other hand, a reference voltage Vref1 is supplied to a V− terminal of the comparator Cmp1 via a resistor R10. The reference voltage Vref1 is set to satisfy a relationship of Vin>Vref1. Further, the V− terminal is connected to a drain of the FET FET1 via a diode D1. An output of the comparator Cmp1 is supplied to a gate Vg of the FET FET1. The output of the comparator Cmp1 is pulled up to the input voltage Vin by a resistor R1.

FIG. 14 illustrates an operation of the DC/DC converter. When the FET FET1 is turned on at time t80, a drain voltage of the FET FET1 is set approximately equal to the input voltage Vin, and a drain current Id starts to flow. At this time, since the reference voltage Vref1 has been set to satisfy the relationship of Vin>Vref1, the diode D1 is reversely biased. Accordingly, an output of the V− terminal is set equal to the reference voltage Vref1. The output voltage Vout (=the voltage of V+ terminal) also increases when the FET FET1 is turned on. When the output of the V+ terminal reaches the reference voltage Vref1, the output of the comparator Cmp1 is set to high impedance. Since the output of the comparator Cmp1 has been pulled up by the resistor R1, the FET FET1 is turned off.

When the FET FET1 is turned off at time t81, a flow of the drain current Id via a route of input voltage Vin→FET FET1→inductor Ls stops. Then, the inductor Ls draws a regenerative current If from the diode Ds side. The regenerative current If flows via a route of ground GND→diode Ds→inductor Ls. At this time, since the diode Ds is forward-biased, a cathode voltage of the diode Ds is approximately set to 0. The current flows via a route of reference voltage Vref1→resistor R10→diode D1. The voltage of V− terminal is approximately set to 0. Accordingly, the output of the comparator Cmp1 is kept at the high impedance, and the off-state of the FET FET1 is maintained. Then, the output voltage Vout (=the voltage of V+ terminal) decreases. The regenerative current If also decreases. When the regenerative current If is set to 0 at time t82, a drain terminal voltage of the FET FET1 slowly increases. Accordingly, the voltage of the V− terminal slowly increases to reach the voltage of the V+ terminal at time t83. Then, the output of the comparator Cmp1 is set to a low level (hereinafter, also referred to as an L level), and the FET FET1 is turned on again. The diode D1 is reversely biased to set the output of the V− terminal equal to the reference voltage Vref1. The output of the comparator Cmp1 is kept at the L level, and the on-state of the FET FET1 is maintained. Subsequently, the operations performed during the times t80 to t83 are repeated to continue the switching of the DC/DC converter.

The output voltage Vout can be set to a desired voltage by setting the reference voltage Vref1 approximately equal to a desired output voltage of the DC/DC converter. This configuration is discussed in Japanese Patent Application Laid-Open No. 2003-284327.

The aforementioned DC/DC converter is generally referred to as a discontinuous current type converter. In the discontinuous current type converter, after the regenerative current If has decreased to 0, the FET FET1 is turned on to cause the drain current Id start flowing from 0. Thus, there is time period when a current flowing through the inductor Ls is 0 (time when a current is discontinuous). This is why the DC/DC converter is referred to as the “discontinuous current type”.

Such a discontinuous current type DC/DC converter has the following problem. As illustrated in FIG. 14, an output current Iout of the DC/DC converter is an average value of current flowing through the inductor Ls. When each of the drain current Id and the regenerative current If has a peak value Ipk, the peak value Ipk is much larger than a value of the output current lout. As a result, an element of a large rated current is necessary for the FET FET1 and the diode Ds, increasing costs. The use of the element of the large rated current increases power consumption during an operation.

To solve the problem, a DC/DC converter of a “continuous current type” has been invented. FIG. 15 illustrates a configuration of the continuous current type DC/DC converter. In this DC/DC converter, an operational amplifier OP1 compares an output voltage Vout with a reference voltage Vref1. The OP1 is an error amplifier, the output of which is supplied as an error amplification signal to a comparator CMP2.

A triangular wave signal is supplied from a triangular wave signal generator (Hereinafter, also referred to as an oscillator (OSC)) to the comparator CMP2. The comparator CMP2 compares the error amplification signal with the triangular wave signal to cause an FET FET1 to perform switching. Thus, a switching frequency of the FET FET1 is equal to a frequency of the triangular wave. The output voltage Vout can be stabilized by increasing and decreasing an operating time of the FET FET1.

As illustrated in FIG. 16, in the DC/DC converter, the drain current Id and the regenerative current If are trapezoidal. There is no time when the current flowing through the inductor Ls is 0. Accordingly, the current always flows through the inductor Ls continuously. This is why the converter is referred to as the “continuous current type”.

In the continuous current type, as compared with the DC/DC converter of the discontinuous current type, since there is no time when the current flowing through the inductor Ls is 0, the peak values Ipk of the drain current Id and the regenerative current If can be approximated to the output current lout. This enables use of elements of a low rated current, thus reducing costs.

However, in the DC/DC converter of the continuous current type, as compared with the discontinuous current type, an operational amplifier and a triangular wave signal generator are additionally required. As a result, the continuous current type has a problem of increases in cost and circuit size.

### SUMMARY OF THE INVENTION

The present invention is directed to a DC/DC converter of a current continuous type inexpensive and small in circuit size.

According to an aspect of the present invention, a converter includes a switching unit configured to switch a voltage to be input, an inductor connected to the switching unit, a conversion unit configured to convert the voltage switched by the switching unit to be supplied to the inductor into a direct current voltage, a detection unit configured to detect the direct current voltage converted by the conversion unit, and a correction unit configured to correct the detected voltage detected by the detection unit, wherein an operation of the switching unit is controlled based on the voltage corrected by the correction unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a DC/DC converter according to a first exemplary embodiment.

FIG. 2 illustrates operation waveforms of the DC/DC converter according to the first exemplary embodiment.

FIG. 3 illustrates a modified example of the DC/DC converter according to the first exemplary embodiment.

FIG. 4 illustrates a DC/DC converter according to a second exemplary embodiment.

FIG. 5 illustrates operation waveforms of the DC/DC converter according to the second exemplary embodiment.

FIG. 6 illustrates a modified example of the DC/DC converter according to the second exemplary embodiment.

FIG. 7 illustrates a DC/DC converter according to a third exemplary embodiment.

FIG. 8 illustrates operation waveforms of the DC/DC converter according to the third exemplary embodiment.

FIG. 9 illustrates a modified example of the DC/DC converter according to the third exemplary embodiment.

FIG. 10 illustrates operation waveforms of the DC/DC converter at the time of activation thereof.

FIG. 11 illustrates a DC/DC converter according to a fourth exemplary embodiment.

FIG. 12 illustrates operation waveforms of the DC/DC converter according to the fourth exemplary embodiment.

FIG. 13 illustrates a conventional DC/DC converter of a discontinuous current type.

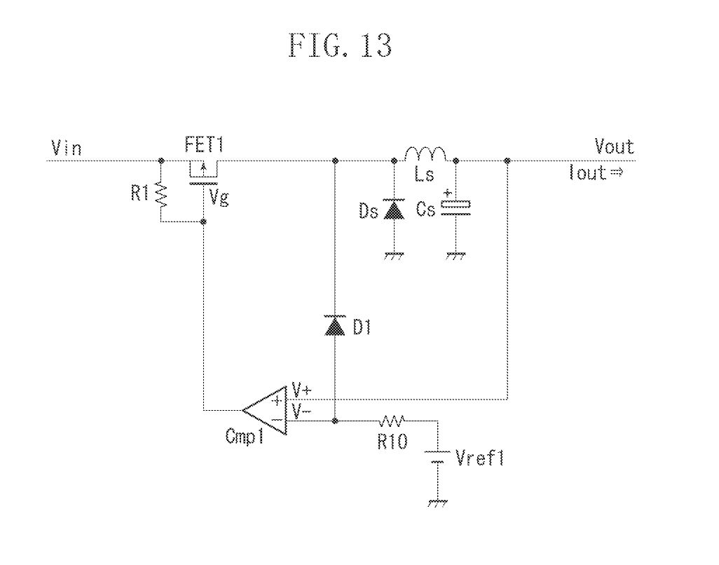

FIG. 14 illustrates operation waveforms of the conventional DC/DC converter of the discontinuous current type.

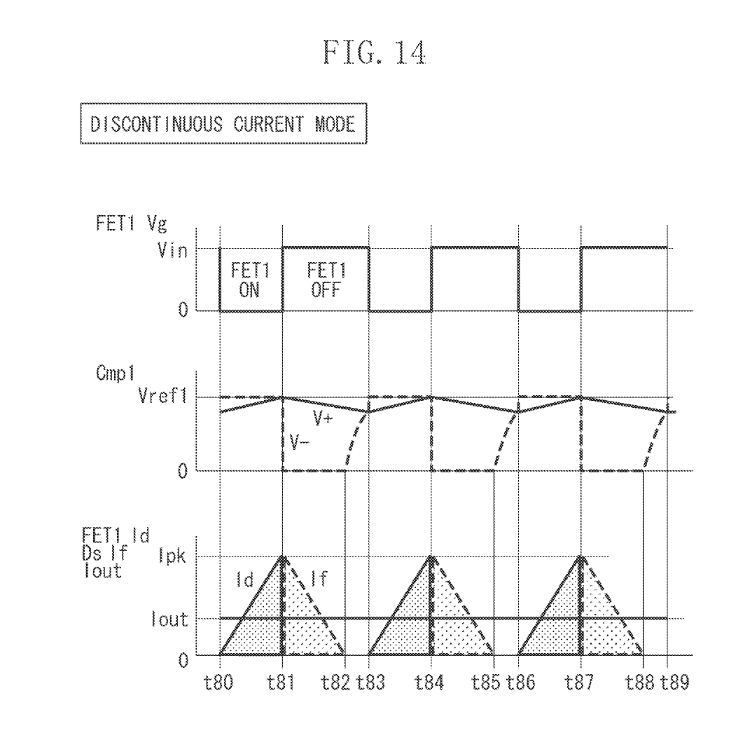

FIG. 15 illustrates a conventional DC/DC converter of a continuous current type.

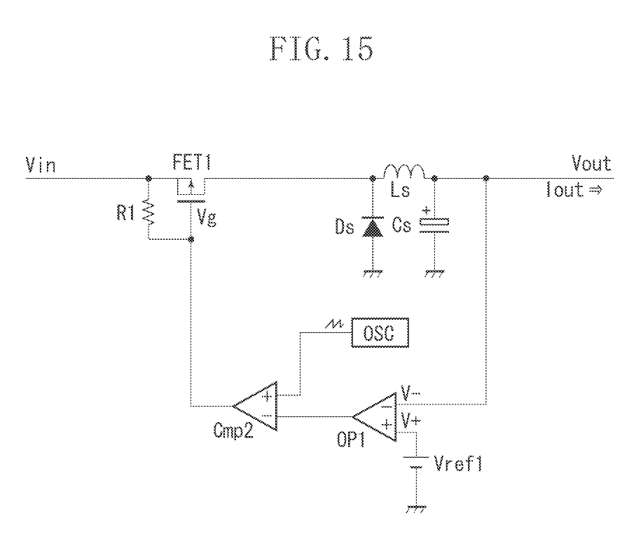

FIG. 16 illustrates operation waveforms of the conventional DC/DC converter of the continuous current type.

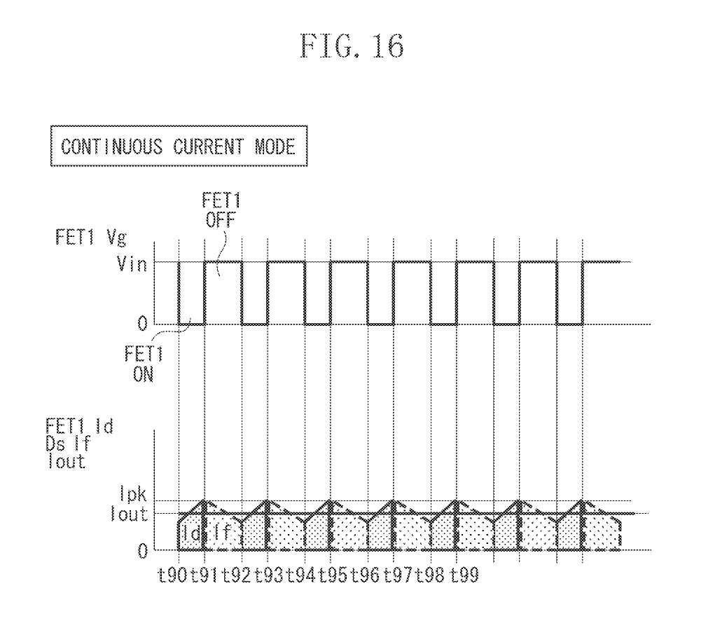

FIGS. 17A and 7B illustrate application examples of the DC/DC converter according to the exemplary embodiment of the present invention.

### DESCRIPTION OF THE EMBODIMENTS

Various exemplary embodiments, features, and aspects of the invention will be described in detail below with reference to the drawings.

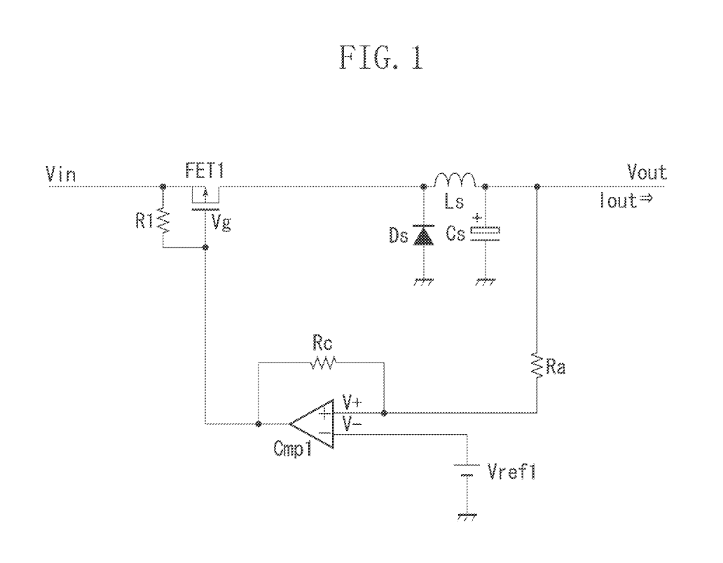

Hereinafter, a first exemplary embodiment will be described. FIG. 1 illustrates a DC/DC converter according to the first exemplary embodiment. A feature of the present exemplary embodiment is that, to set a comparator Cmp1, which is an error amplifier for comparing a detected voltage with a reference voltage, as a schmitt trigger circuit, a positive feedback resistive element (hereinafter, also referred to as a positive feedback resistor) Rc is disposed between an input side and an output side of the comparator Cmp1. This enables a configuration of a DC/DC converter of a continuous current type.

An input voltage Vin is supplied to an FET FET1. When the FET FET1 carries out switching, a pulse voltage is supplied to an inductor Ls. The pulse voltage is converted into a DC voltage via the inductor Ls, a diode Ds, and a capacitor Cs to be an output voltage Vout. The output voltage Vout is supplied to a V+ terminal of the comparator Cmp1 via a detection resistor Ra. The V+ terminal is connected to an output of the comparator Cmp1 via a positive feedback resistive element Rc. The output of the comparator Cmp1 is supplied to a gate Vg of the FET FET1. The output of the comparator Cmp1 is pulled up to the input voltage Vin by a resistor R1. At this time, the positive feedback resistor Rc desirably has a resistance value sufficiently higher than that of the resistor R1. On the other hand, a reference voltage Vref1 is supplied as a reference value to a V− terminal of the comparator Cmp1. The reference voltage Vref1 is set to a value approximately equal to that of a desired output voltage of the DC/DC converter.

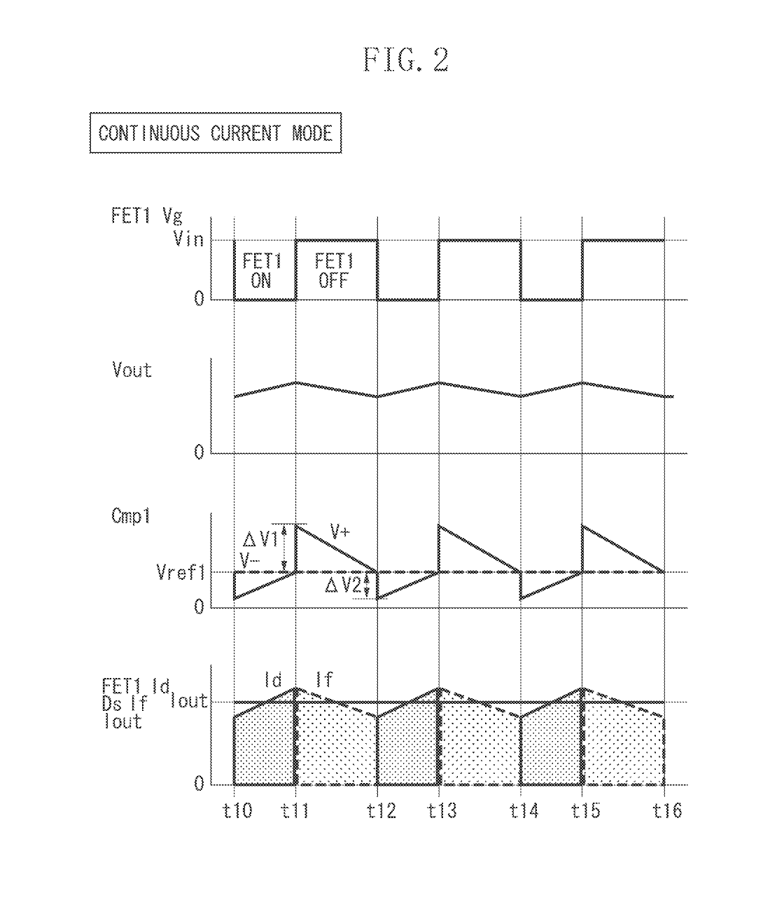

FIG. 2 illustrates an operation of the DC/DC converter. When the FET FET1 is turned on at time t10, a drain voltage of the FET FET1 is set approximately equal to the input voltage Vin, and thus a drain current Id flows. Then, the output voltage Vout increases. The increase of the output voltage Vout is accompanied by an increase of a voltage of the V+ terminal. When the voltage of the V+ terminal increases to reach the reference voltage Vref1, the output of the comparator Cmp1 is set to high impedance. Since the output of the comparator Cmp1 has been pulled up by the resistor R1, the FET FET1 is turned off. After the FET FET1 has been turned off, the drain current Id flowing through a route of input voltage→FET FET1→inductor Ls stops. Then, the inductor Ls draws a regenerative current If from the diode Ds side. The regenerative current If flows through a route of ground GND→diode Ds→inductor Ls.

When the output of the comparator Cmp1 is set to high impedance at time t11, the current flows through a route of input voltage Vin→resistor R1→positive feedback resistor Rc→detection resistor Ra→output voltage Vout. Then, the voltage of the V+ terminal increases by a value ΔV1 from the reference voltage Vref1. The value ΔV1 is an increase of the V+ terminal voltage by the positive feedback resistor Rc (a schmitt trigger circuit). The value ΔV1 is approximately represented by the following expression (1):

$$Δ {V}_{1} ≅ \frac{{V}_{in} - {V}_{out}}{( {R}_{1} + {R}_{c} ) + {R}_{a}} \cdot {R}_{a} \qquad ( 1 )$$

When the values are further approximated by expressions (2) and (3), the value ΔV1 is approximately represented by the following expression (4):

$$\begin{matrix}{R}_{c} >> {R}_{1} ⇒ ( {R}_{1} + {R}_{c} ) + {R}_{a} ≅ {R}_{a} + {R}_{c} & ( 2 ) \\ {V}_{out} ≅ {V}_{ref} & ( 3 ) \\ Δ {V}_{1} ≅ \frac{{V}_{in} - {V}_{ref}}{{R}_{a} + {R}_{c}} \cdot {R}_{a} & ( 4 )\end{matrix}$$

After the voltage of the V+ terminal has increased by the value ΔV1 from the reference voltage Vref1, the output of the comparator Cmp1 is kept at the high impedance. Thus, the off-state of the FET FET1 is maintained. Then, the output voltage Vout decreases. The decrease of the output voltage Vout is accompanied by a decrease of the voltage of the V+ terminal.

When the voltage of the V+ terminal decreases to reach the reference voltage Vref1 at time t12, the output of the comparator Cmp1 is set to a low level (an L level). That turns ON the FET FET1 again. Then, the current flows through a route of output voltage Vout→detection resistor Ra→positive feedback resistor Rc→output (the L level) side of comparator Cmp1. Then, the voltage of the V+ terminal decreases by a value ΔV2 from the reference voltage Vref1. The value ΔV2 is a decrease of the V+ terminal voltage by the positive feedback resistor Rc. The value ΔV2 is approximately represented by the following expression (5):

$$Δ {V}_{2} ≅ \frac{{V}_{out}}{{R}_{a} + {R}_{c}} \cdot {R}_{a} \qquad ( 5 )$$

When the values are further approximated by the expression (3), the value ΔV2 is approximately represented by the following expression (6):

$$Δ {V}_{2} ≅ \frac{{V}_{ref}}{{R}_{a} + {R}_{c}} \cdot {R}_{a} \qquad ( 6 )$$

After the voltage of the V+ terminal has decreased by the value ΔV2 from the reference voltage Vref1, the output of the comparator Cmp1 is kept at the L level. The on-state of the FET FET1 is maintained. When the FET FET1 is turned on, the drain voltage of the FET FET1 is set approximately equal to the input voltage Vin, and thus the drain current Id flows. Then, the output voltage Vout increases. The increase of the output voltage Vout is accompanied by an increase of the voltage of the V+ terminal. Subsequently, the DC/DC converter continues the switching by repeating the operations performed during t10 to t12. Thus, the feature of the present exemplary embodiment is that the function of correcting the voltage detected by the detection resistor Ra by the positive feedback resistor Rc.

In the operation, parameters concerning the on and off timing of the FET FET1 are the threshold voltage variation values ΔV1 and ΔV2 of the comparator Cmp1 in the schmitt trigger circuit. In the expressions (4) and (6), the value ΔV1 and the value ΔV2 are approximately determined by the values of the input voltage Vin, the reference voltage Vref1, the detection resistor Ra, and the positive feedback resistor Rc. The value ΔV1 and the value ΔV2 are approximately constant irrespective of the values of the drain current Id and the regenerative current If. Thus, the DC/DC converter operates according to a comparison result of the comparator Cmp1, which is an operation of a continuous current type.

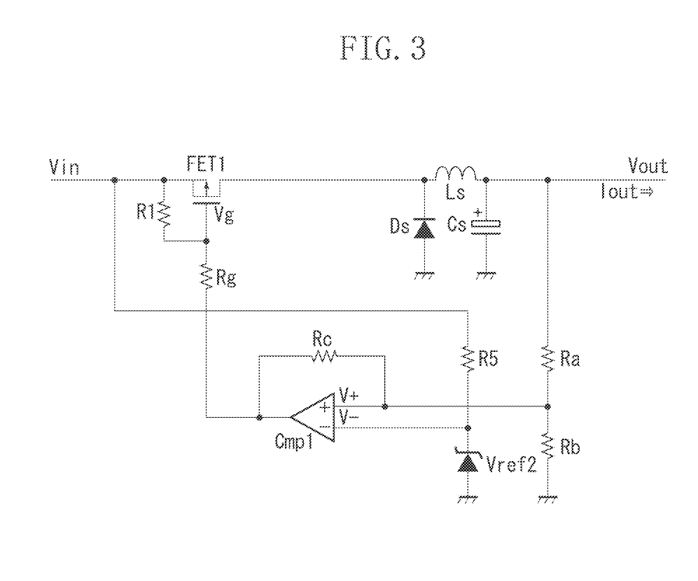

Even when a configuration of the input to the comparator Cmp1 is changed to include a zener diode, a gate resistor Rg, and a voltage dividing resistor Rb as illustrated in FIG. 3, the operation of the DC/DC converter with the continuous current type may be achieved.

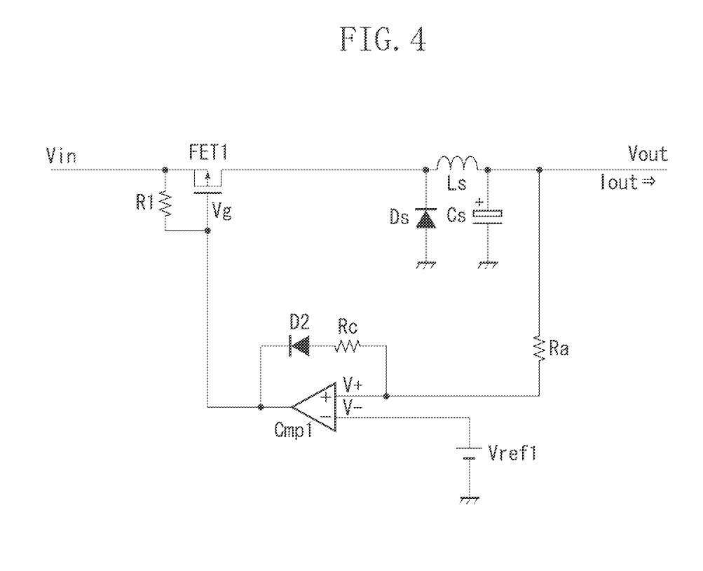

FIG. 4 illustrates a DC/DC converter according to a second exemplary embodiment. A feature of the present exemplary embodiment is a series circuit configured by connecting a positive feedback resistive element Rc and a diode D2 serving as a rectifying element in series.

An input voltage Vin is supplied to an FET FET1. When the FET FET1 carries out switching, a pulse voltage is supplied to an inductor Ls. The pulse voltage is converted into a DC voltage via the inductor Ls, a diode Ds, and a capacitor Cs to be an output voltage Vout. The output voltage Vout is supplied to a V+ terminal of the comparator Cmp1 via a detection resistor Ra. The V+ terminal is connected to an output side of the comparator Cmp1 via the positive feedback resistor Rc and the diode D2. A connection direction of the diode D2 is the direction (the forward direction) which a cathode is connected to the output side of the comparator Cmp1. The output of the comparator Cmp1 is supplied to a gate Vg of the FET FET1. The output of the comparator Cmp1 is pulled up to the input voltage Vin by a resistor R1. On the other hand, a reference voltage Vref1 is supplied to a V− terminal of the comparator Cmp1. The reference voltage Vref1 is set to a value approximately equal to that of a desired output voltage of the DC/DC converter.

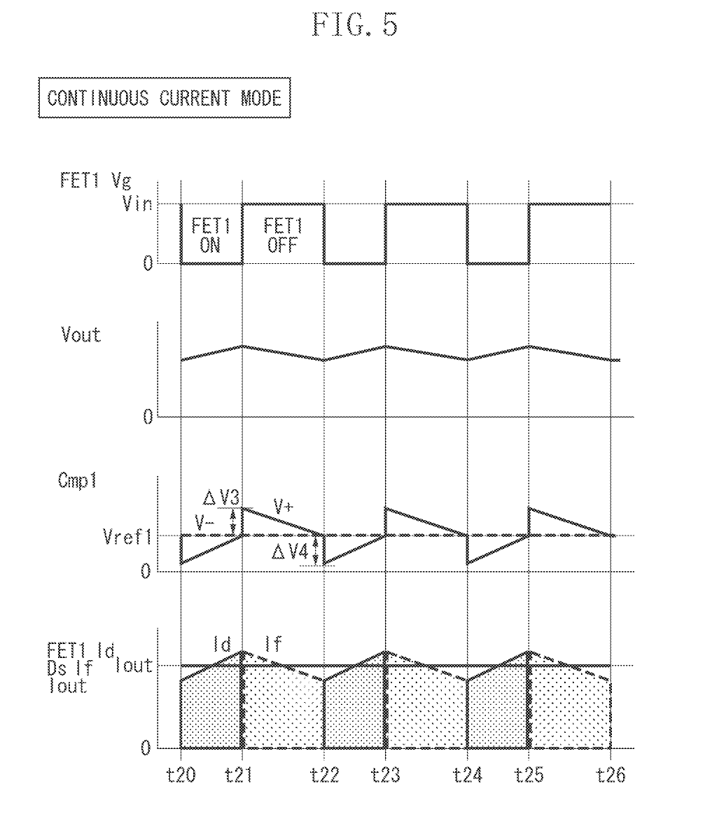

FIG. 5 illustrates an operation of the DC/DC converter. When the FET FET1 is turned on at time t20, a drain voltage of the FET FET1 is set approximately equal to the input voltage Vin. Thus, drain current Id flows. Then, the output voltage Vout increases. The increase of the output voltage Vout is accompanied by an increase of a voltage of the V+ terminal. When the voltage of the V+ terminal increases to reach the reference voltage Vref1, the output of the comparator Cmp1 is set to high impedance. Since the output of the comparator Cmp1 has been pulled up by the resistor R1, the FET FET1 is turned off. After the FET FET1 has been turned off, the drain current Id flowing through a route of input voltage Vin→FET FET1→inductor Ls stops. Then, the inductor Ls draws a regenerative current If from the diode Ds side. The regenerative current If flows through a route of ground GND→diode Ds→inductor Ls.

When the output of the comparator Cmp1 is set to high impedance at time t21, the diode Ds is reversely biased.

Current flowing through a route of output voltage Vout→detection resistor Ra→positive feedback resistor Rc→diode D2→output (an L level) side of comparator Cmp stops. Then, the voltage of the V+ terminal increases by a value ΔV3 from the reference voltage Vref1. The value ΔV3 is an increase of the V+ terminal voltage by the positive feedback resistor Rc (a schmitt trigger circuit). The value ΔV3 is approximately represented by the following expression (7):

$$Δ {V}_{3} ≅ \frac{{V}_{out}}{{R}_{a} + {R}_{c}} \cdot {R}_{a} \qquad ( 7 )$$

When the values are further approximated by an expression (8), the value ΔV3 is approximately represented by the following expression (9):

$$\begin{matrix}{V}_{out} ≅ {V}_{ref} & ( 8 ) \\ Δ {V}_{3} ≅ \frac{{V}_{ref}}{{R}_{a} + {R}_{c}} \cdot {R}_{a} & ( 9 )\end{matrix}$$

After the voltage of the V+ terminal has increased by the value ΔV3 from the reference voltage Vref1, the output of the comparator Cmp1 is kept at the high impedance, and the off-state of the FET FET1 is maintained. Then, the output voltage Vout decreases. The decrease of the output voltage Vout is accompanied by a decrease of the voltage of the V+ terminal.

When the voltage of the V+ terminal decreases to reach the reference voltage Vref1 at time t22, the output of the comparator Cmp1 is set to a low level (an L level). That turns on the FET FET1 again. Then, the diode D2 is forward biased, and the current flows through a route of output voltage Vout→detection resistor Ra→positive feedback resistor Rc→diode D2→output (the L level) side of comparator Cmp1. Then, the voltage of the V+ terminal decreases by a value ΔV4 from the reference voltage Vref1. The value ΔV4 is a decrease of the V+ terminal voltage by the positive feedback resistor Rc. The value ΔV4 is approximately represented by the following expression (10):

$$Δ {V}_{4} ≅ \frac{{V}_{out}}{{R}_{a} + {R}_{c}} \cdot {R}_{a} \qquad ( 10 )$$

When the values are further approximated by the expression (3), the value ΔV4 is approximately represented by the following expression (11):

$$Δ {V}_{4} ≅ \frac{{V}_{ref}}{{R}_{a} + {R}_{c}} \cdot {R}_{a} \qquad ( 11 )$$

The following expression (12) is established from the expressions (9) and (11):

$$Δ {V}_{3} ≅ Δ {V}_{4} ≅ \frac{{V}_{ref}}{{R}_{a} + {R}_{c}} \cdot {R}_{a} \qquad ( 12 )$$

After the voltage of the V+ terminal has decreased by the value ΔV4 from the reference voltage Vref1, the output of the comparator Cmp1 is kept at the L level, and the on-state of the FET FET1 is maintained. When the FET FET1 is turned on, the drain voltage of the FET FET1 is set approximately equal to the input voltage Vin. Thus, the drain current Id flows. Then, the output voltage Vout increases. The increase of the output voltage Vout is accompanied by an increase of the voltage of the V+ terminal. Subsequently, the DC/DC converter continues the switching by repeating the operations performed during t20 to t22.

In the operation, parameters concerning the on and off timing of the FET FET1 are the threshold voltage variation values ΔV3 and ΔV4 of the comparator Cmp1 in the schmitt trigger circuit. In the expression (12), the value ΔV3 and the value ΔV4 are approximately determined by the values of the reference voltage Vref1, the detection resistor Ra, and the positive feedback resistor Rc.

The value ΔV3 and the value ΔV4 are approximately constant irrespective of the drain current Id and the regenerative current If. Thus, the DC/DC converter operates as a continuous current type.

In the first exemplary embodiment, as can be understood from the expression (4), the value ΔV1 changes based on the value of the input voltage Vin. In the present exemplary embodiment, as can be understood from the expression (12), none of the value ΔV3 and the value ΔV4 changes based on the value of the input voltage Vin. This can achieve a more stable continuous current operation. This effect is provided by the diode D2 added in the present exemplary embodiment.

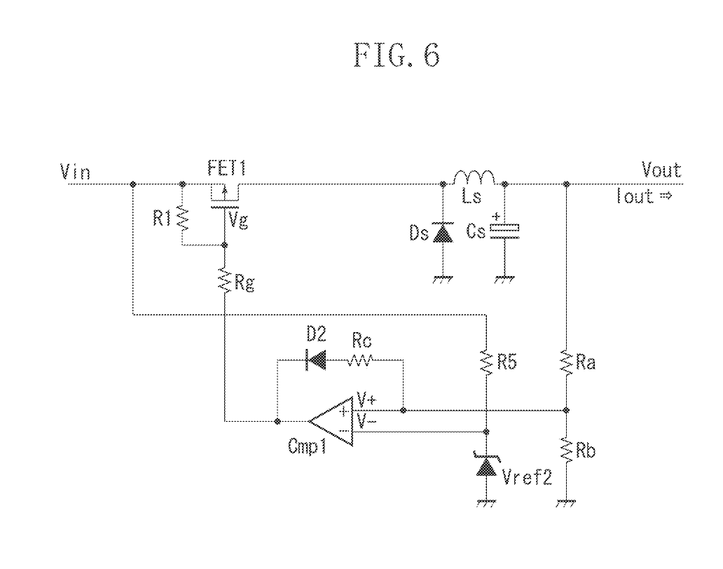

Even when a configuration of the input to the comparator Cmp1 is changed to include a zener diode, a gate resistor Rg, and a voltage dividing resistor Rb as illustrated in FIG. 6, the operation of the continuous current type may be achieved.

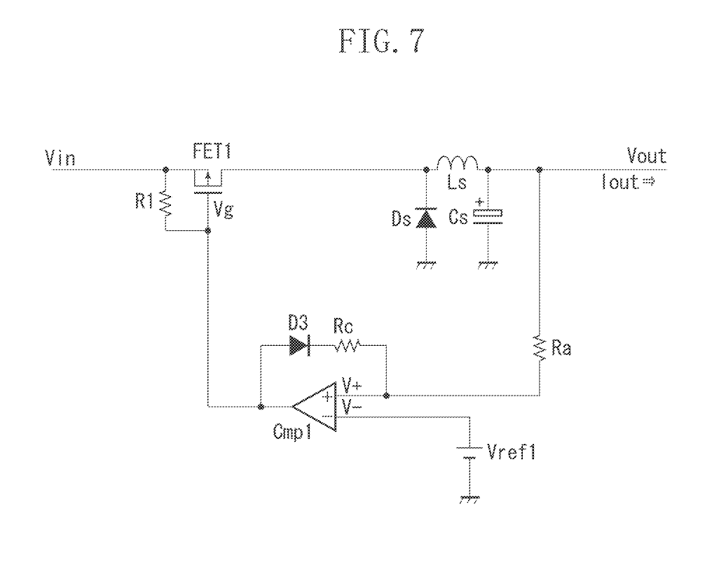

FIG. 7 illustrates a DC/DC converter according to a third exemplary embodiment. A feature of the present exemplary embodiment is that a connection direction of a diode D3 connected to a positive feedback resistive element Rc in series is different from that of the diode D2 according to the second exemplary embodiment.

An input voltage Vin is supplied to an FET FET1. When the FET FET1 carries out switching, a pulse voltage is supplied to an inductor Ls. The pulse voltage is converted into a DC voltage via an inductor Ls, a diode Ds, and a capacitor Cs to be an output voltage Vout. The output voltage Vout is supplied to a V+ terminal of the comparator Cmp1 via a detection resistor Ra. The V+ terminal is connected to an output side of the comparator Cmp1 via the positive feedback resistor Rc and the diode D3. The connection direction of the diode D3 is the direction which an anode is connected to the output of the comparator Cmp1. The output of the comparator Cmp1 is supplied to a gate Vg of the FET FET1. The output of the comparator Cmp1 is pulled up to the input voltage Vin by a resistor R1. At this time, the positive feedback resistor Rc desirably includes resistance sufficiently higher than the resistor R1. On the other hand, a reference voltage Vref1 is supplied to a V− terminal of the comparator Cmp1. The reference voltage Vref1 is set to a value approximately equal to that of a desired output voltage of the DC/DC converter.

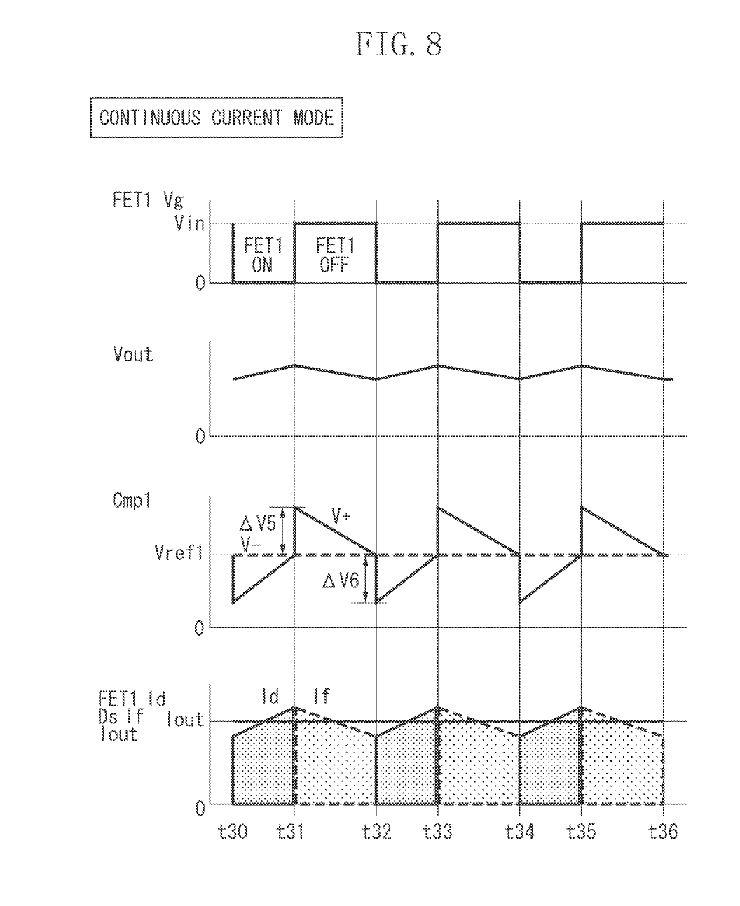

FIG. 8 illustrates an operation of the DC/DC converter. When the FET FET1 is turned on at time t30, a drain voltage of the FET FET1 is set approximately equal to the input voltage Vin. Thus, a drain current Id flows. Then, the output voltage Vout increases. The increase of the output voltage Vout is accompanied by an increase of a voltage of the V+ terminal. When the voltage of the V+ terminal increases to reach the reference voltage Vref1, the output of the comparator Cmp1 is set to high impedance. Since the output of the comparator Cmp1 has been pulled up by the resistor R1, the FET FET1 is turned off. After the FET FET1 has been turned off, the drain current Id flowing through a route of input voltage Vin→FET FET1→inductor Ls stops. Then, the inductor Ls draws a regenerative current If from the diode Ds side. The regenerative current If flows through a route of ground GND→diode Ds→inductor Ls.

When the output of the comparator Cmp1 is set to high impedance at time t31, the current flows through a route of input voltage Vin→resistor R1→diode D3→positive feedback resistor Rc→detection resistor Ra→output voltage Vout. Then, the voltage of the V+ terminal increases by a value ΔV5 from the reference voltage Vref1. The value ΔV5 is an increase of the V+ terminal voltage by the positive feedback resistor Rc (a schmitt trigger circuit). The value ΔV5 is approximately represented by the following expression (13):

$$Δ {V}_{5} ≅ \frac{{V}_{in} - {V}_{out}}{( {R}_{1} + {R}_{c} ) + {R}_{a}} \cdot {R}_{a} \qquad ( 13 )$$

When the values further approximated by expressions (14) and (15), the value ΔV5 is approximately represented by the following expression (16):

$$\begin{matrix}{R}_{c} >> {R}_{1} ⇒ ( {R}_{1} + {R}_{c} ) + {R}_{a} ≅ {R}_{a} + {R}_{c} & ( 14 ) \\ {V}_{out} ≅ {V}_{ref} & ( 15 ) \\ Δ {V}_{5} ≅ \frac{{V}_{in} - {V}_{ref}}{{R}_{a} + {R}_{c}} \cdot {R}_{a} & ( 16 )\end{matrix}$$

After the voltage of the V+ terminal has increased by the value ΔV5 from the reference voltage Vref1, the output of the comparator Cmp1 is kept at the high impedance. The off-state of the FET FET1 is maintained. Then, the output voltage Vout decreases. The decrease of the output voltage Vout is accompanied by a decrease of the voltage of the V+ terminal.

When the voltage of the V+ terminal decreases to reach the reference voltage Vref1 at time t32, the output of the comparator Cmp1 is set to a low level (an L level). That turns on the FET FET1 again. Then, the diode D3 is reversely biased. Thus, the current flowing through a route of input voltage Vin→resistor R1→diode D3→positive feedback resistor Rc→detection resistor Ra→output voltage Vout stops. Then, the voltage of the V+ terminal decreases by a value ΔV6 from the reference voltage Vref1. The value ΔV6 is a decrease of the V+ terminal voltage by the positive feedback resistor Rc. The value ΔV6 is approximately represented by the following expression (17):

$$Δ {V}_{6} ≅ \frac{{V}_{in} - {V}_{out}}{( {R}_{1} + {R}_{c} ) + {R}_{a}} \cdot {R}_{a} \qquad ( 17 )$$

When the values further approximated by the expressions (14) and (15), the value ΔV6 is approximately represented by the following expression (18):

$$Δ {V}_{6} ≅ \frac{{V}_{in} - {V}_{ref}}{{R}_{a} + {R}_{c}} \cdot {R}_{a} \qquad ( 18 )$$

The following expression (19) is established from the expressions (16) and (18):

$$Δ {V}_{5} ≅ Δ {V}_{6} ≅ \frac{{V}_{in} - {V}_{ref}}{{R}_{a} + {R}_{c}} \cdot {R}_{a} \qquad ( 19 )$$

After the voltage of the V+ terminal has decreased by the value ΔV6 from the reference voltage Vref1, the output of the comparator Cmp1 is kept at the L level. The on-state of the FET FET1 is maintained. When the FET FET1 is turned on, the drain voltage of the FET FET1 is set approximately equal to the input voltage Vin. Thus, drain current Id flows. Then, the output voltage Vout increases. The increase of the output voltage Vout is accompanied by an increase of the voltage of the V+ terminal. Subsequently, the DC/DC converter continues the switching by repeating the operation performed during t30 to t32.

In the operation, parameters concerning the on and off timing of the FET FET1 are the threshold voltage variation values ΔV5 and ΔV6 of the comparator Cmp1 in the schmitt trigger circuit. In the expression (12), the value ΔV5 and the value ΔV6 are approximately determined by the values of the input voltage Vin, the reference voltage Vref1, the detection resistor Ra, and the positive feedback resistor Rc. The value ΔV5 and the value ΔV6 are approximately constant irrespective of the drain current Id and the regenerative current If. Thus, the DC/DC converter operates as a continuous current type.

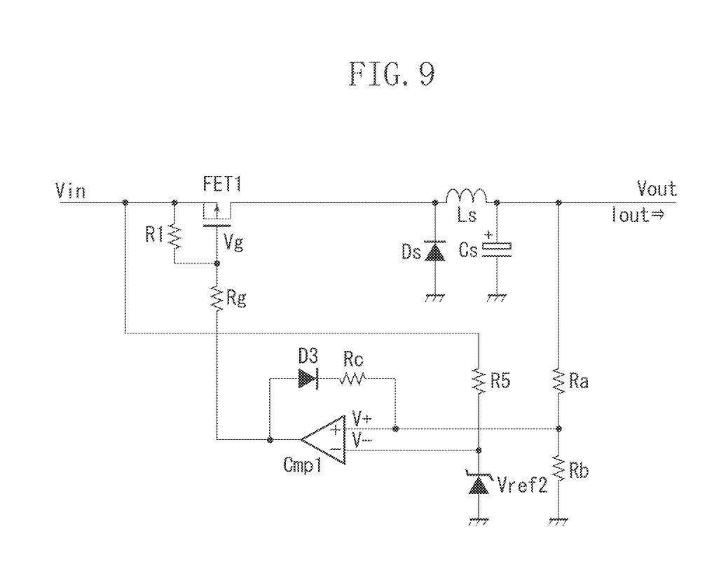

Even when a configuration of the input to the comparator Cmp1 is changed to include a zener diode, a gate resistor Rg, and a voltage dividing resistor Rb as illustrated in FIG. 9, the operation of the continuous current type may be achieved.

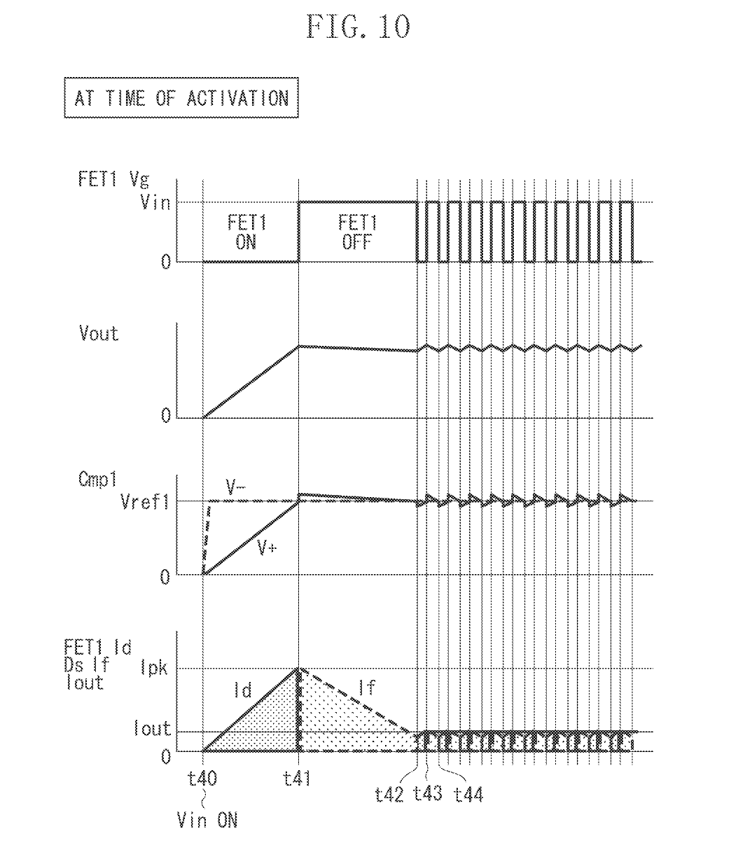

Next, a fourth exemplary embodiment will be described. A configuration of the present exemplary embodiment is based on the configuration of the first exemplary embodiment. FIG. 10 illustrates an operation when the input voltage Vin rises from 0 at the activation of a power source in the DC/DC converter according to the first exemplary embodiment illustrated in FIG. 1.

When the input voltage Vin is applied from 0 at time t40, the voltage of the V− terminal of the comparator Cmp1 is instantaneously set equal to the reference voltage Vref1. At this time, since the output voltage Vout is 0, the voltage of the V+ terminal of the comparator Cmp1 is 0. Accordingly, the output of the comparator Cmp1 is set to an L level, turning on the FET FET1. Then, the drain current Id of the FET FET1 starts to flow, and gradually increases. This is accompanied by increases of the output voltage Vout and the voltage of the V+ terminal.

When the voltage of the V+ terminal increases to reach the reference voltage Vref1 at time t41, the output of the comparator Cmp1 is set to high impedance. Since the output of the comparator Cmp1 has been pulled up by the resistor R1, the FET FET1 is turned off. After the FET FET1 has been turned off, the drain current Id flowing through a route of input voltage Vin→FET FET1→inductor Ls stops. Then, the inductor Ls draws a regenerative current If from the diode Ds side. The regenerative current If flows through a route of ground GND→diode Ds→inductor Ls.

In a first on and off period of the FET FET1 after the input voltage Vin has been applied, peak values Ipk of the drain current Id flowing through the FET and the regenerative current If flowing through the diode Ds are extremely large. In view of such peak values at the time of activation, therefore, a device with a large rated current may be required for the FET FET1 and the diode Ds.

To deal with such a situation, a feature of the fourth exemplary embodiment includes a current limitation circuit for limiting the drain current Id flowing through the FET FET1, and a timer circuit for continuing (maintaining), when the drain current Id is limited by the current limitation circuit, the limiting operation for a predetermined time. The inclusion of the current limitation circuit and the timer circuit enables the DC/DC converter to maintain the peak values Ipk of the drain current Id and the regenerative current If a low level.

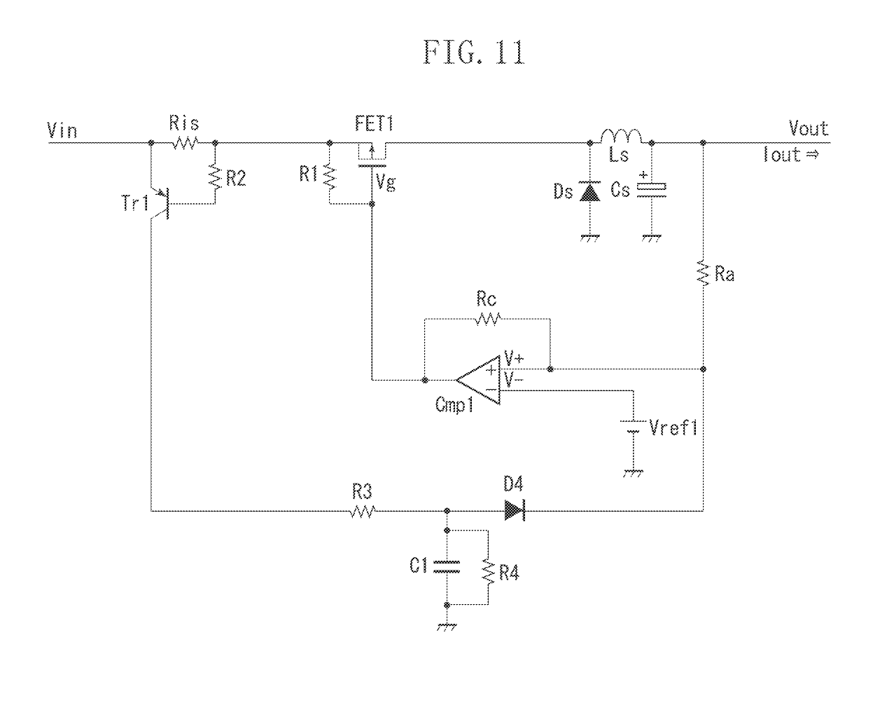

FIG. 11 illustrates the DC/DC converter according to the present exemplary embodiment. The DC/DC converter is configured by being added the current limitation circuit and the timer circuit to the DC/DC converter according to the first exemplary embodiment illustrated in FIG. 1.

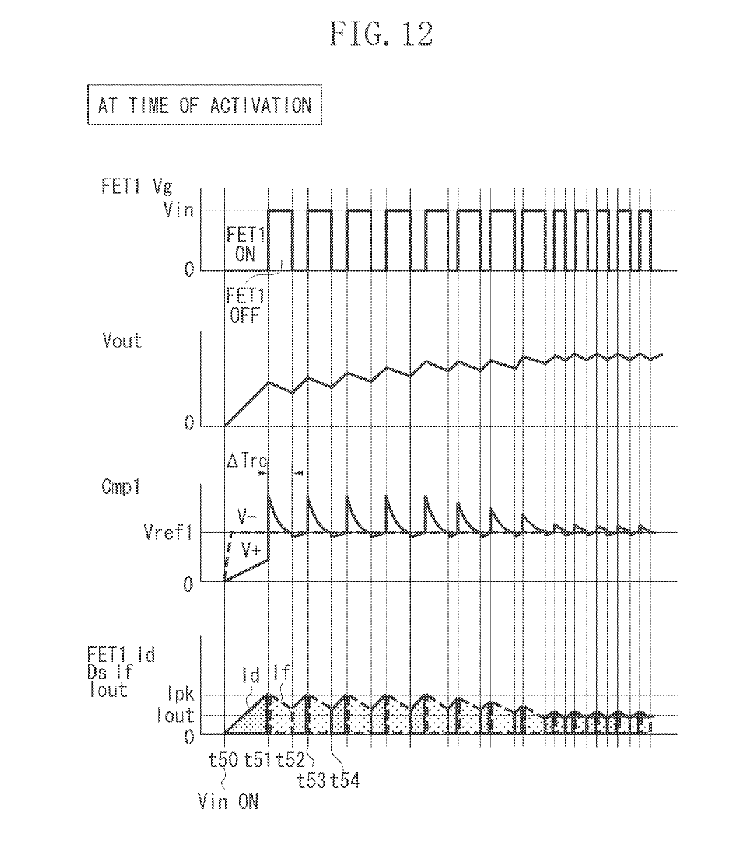

The current limitation circuit includes a current detection resistors Ris, and a resistor R2, and a transistor Tr1. The timer circuit includes a resistor R3, a capacitor C1, a resistor R4, and a diode D4. FIG. 12 illustrates an operation of the DC/DC converter illustrated in FIG. 11 when the input voltage Vin is applied from 0.

When the input voltage Vin is applied from 0 at time t50, the voltage of the V− terminal of the comparator Cmp1 is instantaneously set equal to the reference voltage Vref1. At this time, since the output voltage Vout is 0, the voltage of the V+ terminal of the comparator Cmp1 is 0. Accordingly, the output of the comparator Cmp1 is set to an L level, turning on the FET FET1. Then, the drain current Id starts to flow through a route of input voltage Vin→current detection resistors Ris→FET FET1→inductor Ls, and gradually increases. This is accompanied by increases of the output voltage Vout and the voltage of the V+ terminal. The drain current Id is converted into a voltage by the current detection resistors Ris. This voltage is supplied to the transistor Tr1 between an emitter and a base.

When the drain current ID increases and both end voltages of the current detection resistors Ris reach an on-voltage Vbe (generally, about 0.6 V) in the transistor Tr1 between the emitter and the base, the transistor Tr1 is turned on. The following expression (20) is approximately established:

$$Ipk ≅ \frac{{V}_{be}}{{R}_{is}} \qquad ( 20 )$$

After the transistor Tr1 has been turned on, a voltage is supplied through a route of input voltage Vin→transistor Tr1→resistor R3→diode D4 V+ terminal of comparator Cmp1. The voltage of the V+ terminal is approximately set equal to the input voltage Vin. (A resistance value of the resistor R3 is sufficiently lower than those of the detection resistor Ra, positive feedback resistor Rc, and resistor R4). Thus, the output of the comparator Cmp1 is set to high impedance. Since the output of the comparator Cmp1 has been pulled up by the resistor R1, the FET FET1 is turned off. After the FET FET1 has been turned off, the drain current Id flowing through a route of input voltage Vin→current detection resistors Ris→FET FET1→inductor Ls stops. Then, the inductor Ls draws a regenerative current If from the diode Ds side. The regenerative current If flows through a route of ground GND→diode Ds→inductor Ls.

At this time, since a collector voltage of the transistor Tr1 has been supplied to the capacitor C1 via the resistor R3, a voltage of the capacitor C1 is also instantaneously charged approximately equal to the input voltage Vin. The charging voltage of the capacitor C1 is discharged from the detection resistor Ra via the resistor R4 and the diode D4 to be lowered. During a time transition indicated by a value ΔTrc during which the charging voltage drops from the input voltage Vin to the reference voltage Vref1, the output of the comparator Cmp1 is kept at high impedance. The off-state of the FET FET1 is continued.

When the charging voltage of the capacitor C1 drops to the reference voltage Vref1 at time t52, the voltage of the V+ terminal reaches the reference voltage Vref1. The output of the comparator Cmp1 is set to an L level. After the output of the comparator Cmp1 has been set to the L level, the FET FET1 is tuned on again. Subsequently, the operation is continued.

In the operation, as can be understood from the expression (20), peak values Ipk of the drain current Id and the regenerative current If are limited to predetermined values (limit values) defined by the current detection resistors Ris and the on-voltage Vbe.

### Application Example of Power Source Including Discharge Circuit According to the Present Exemplary Embodiments

A power source including the above-described discharge circuit may be applied as a low-voltage power source to an image forming apparatus, such as a printer, a copying machine, or a facsimile. The power source may be used for supplying power to a controller 300 as a control unit in the image forming apparatus.

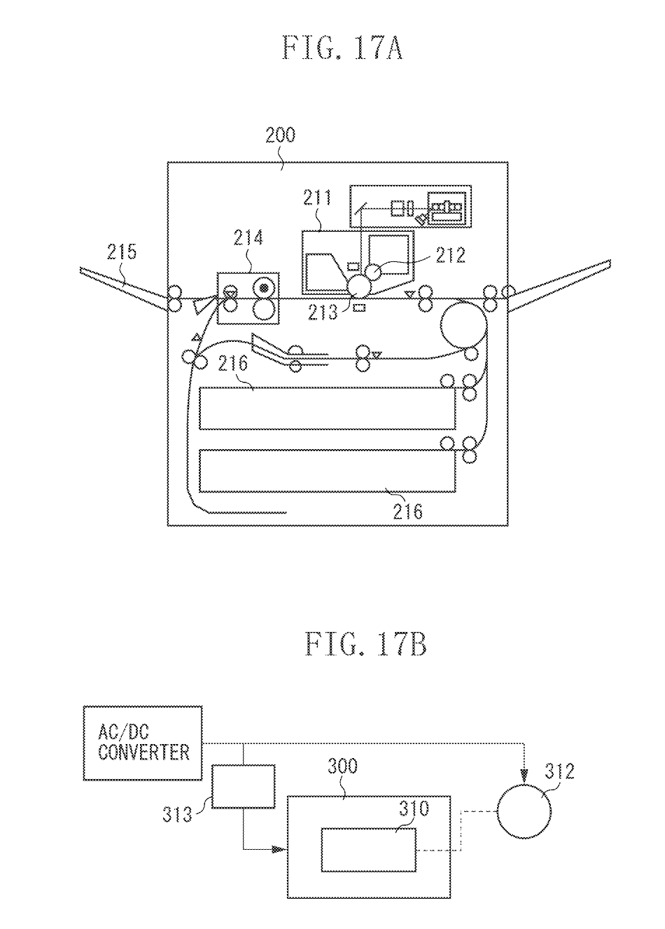

FIG. 17A schematically illustrates a configuration of a laser beam printer as an example of the image forming apparatus. The laser beam printer 200 includes a photosensitive drum 211 serving as an image bearing member on which a latent image is formed as an image forming unit 210, and a development unit 212 for developing the latent image formed on the photosensitive drum 211 by toner. The toner image developed on the photosensitive drum 211 is transferred to a sheet (not illustrated) as a recording material supplied from a cassette 216. The toner image transferred to the sheet is fixed by a fixing device 214, and then the sheet is discharged to a tray 215. FIG. 17B illustrates a power supply line for a controller as a control unit of the image forming apparatus. FIG. 17B illustrates a configuration including an alternating current (AC)/DC converter for converting an AC voltage from a commercial AC power source into a DC voltage, and a DC/DC converter 313 connected subsequent to the AC/DC converter. The DC/DC converter 313 may be applied as a low-voltage power source for supplying power to the controller 300 that includes a central processing unit (CPU) 310 for controlling an image forming operation of the image forming apparatus. In FIG. 17B, a voltage from the AC/DC converter is output to a motor 312 that is a drive unit, and the controller 300 controls an operation of the motor 312. The application of the exemplary embodiments of the present invention is not limited to such image forming apparatus. The exemplary embodiments may be applied as a low-voltage power source to other electronic devices.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-090443 filed Apr. 11, 2012, which is hereby incorporated by reference herein in its entirety.

What is claimed is:

1. A converter comprising:
a switching unit configured to switch a voltage to be input;
an inductor connected to the switching unit;
a conversion unit configured to convert the voltage switched by the switching unit to be supplied to the inductor into a direct current voltage;
a detection unit configured to detect the direct current voltage converted by the conversion unit; and
a correction unit configured to correct the detected voltage detected by the detection unit,
wherein an operation of the switching unit is controlled based on the voltage corrected by the correction unit.

2. The converter according to claim 1, further comprising a comparison unit configured to compare the voltage detected by the detection unit with a reference value,
wherein the correction unit corrects the detected voltage detected by the detection unit based on a comparison result obtained by the comparison unit.

3. The converter according to claim 2, wherein the detection unit includes a resistive element connected between an output side of the direct current voltage and an input side of the comparison unit.

4. The converter according to claim 2, wherein the comparison unit includes a comparator.

5. The converter according to claim 2, wherein the correction unit includes a resistive element connected to an output side of the comparison unit and an output side of the detection unit.

6. The converter according to claim 2, wherein the correction unit includes a series circuit including a resistive element and a rectifying element, and is connected to an output side of the comparison unit and an output side of the detection unit.

7. The converter according to claim 6, wherein the rectifying element is connected so that a forward direction of the rectifying element corresponds to a direction toward the output side of the comparison unit from the detection unit.

8. The converter according to claim 6, wherein the rectifying element is connected so that a forward direction of the rectifying element corresponds to a direction toward the detection unit from the output side of the comparison unit.

9. The converter according to claim 1, further comprising:
a current detection unit configured to detect a current flowing through the switching unit;
a current limitation unit configured to turn off the switching unit when a value detected by the current detection unit exceeds a predetermined value; and
a timer configured to hold an output of the current limitation unit for a predetermined time to continue an off-state of the switching unit for a predetermined time.

10. The converter according to claim 9, wherein the current detection unit includes a resistive element.

11. The converter according to claim 9, wherein the current limitation unit includes a transistor, and the current detection unit is connected between an emitter and a base of the transistor.

12. The converter according to claim 9, wherein the timer includes a capacitor charged by the output of the current limitation unit, and a resistive element configured to discharge electricity from the capacitor charged by the output of the current limitation unit within predetermined time.

13. An image forming apparatus comprising:
an image forming unit configured to form an image;
a controller configured to control an operation of the image forming unit; and
a converter configured to supply power to the controller,
wherein the converter includes:
a switching unit configured to switch a voltage to be input;
an inductor connected to the switching unit;
a conversion unit configured to convert the voltage switched by the switching unit to be supplied to the inductor into a direct current voltage;
a detection unit configured to detect the direct current voltage converted by the conversion unit; and
a correction unit configured to correct the detected voltage detected by the detection unit,
wherein an operation of the switching unit is controlled based on the voltage corrected by the correction unit.
